(19) United States
(12) Patent Application Publication
(10) Pub. No.: US 2005/0240766 A1
(43) Pub. Date: Oct. 27, 2005

(54) Application management system, device with application execution function, portable terminal with application management function, device program, program and memory medium for portable terminal and application management method

(76) Inventor: Taro Ishige, Beppu (JP)

Correspondence Address: HARNESS, DICKEY & PIERCE, P.L.C., P.O. BOX 828, BLOOMFIELD HILLS, MI, 48303, US

(21) Appl. No.: 11/110,634

(22) Filed: Apr. 20, 2005

(30) Foreign Application Priority Data
Apr. 22, 2004 (JP) 2004-126830
Jan. 18, 2005 (JP) 2005-010443

(51) Int. Cl. H04L 9/00

(52) U.S. Cl. 713/175

(57) ABSTRACT

An application management system having a portable terminal that manages whether an application can be executed by another device such as an off-line printer. The portable terminal includes an application memory unit that stores the application as well as correlates and stores license information for certifying the eligibility for use of the application; an application distribution unit that distributes the application and license information to the device; and a license certification unit that certifies the eligibility for use of the application. The device includes an application receiving unit that receives the application and the license information; a license confirmation unit that requests confirmation about the eligibility for use of the application; and an application execution unit that executes the application based on the result received from the license certification unit.

### RELATED APPLICATIONS

This application claims priority to Japanese Patent Application No. 2004-126830 filed Apr. 22, 2004 and 2005-010443 filed Jan. 18, 2005 which are hereby expressly incorporated by reference herein in their entirety.

### BACKGROUND OF THE INVENTION

1. Technical Field

The present invention relates to an application management system that manages applications, a device, a portable terminal, a program and memory medium, and a method, in particular, an application management system suitable for, without establishing a connection environment with networks and local terminals, distributing applications and managing licenses, and managing licenses of a plurality of applications separately; a device with application execution function; a portable terminal with application management function; a device program; a program and memory medium for the portable terminal; and an application management method.

2. Related Art

Recently, with advance in higher performance printers, printers capable of customizing by installing an application are put into practical use. In order to more effectively make use of such customized printers, it is necessary to establish a distribution method of the applications to customized printers and a management method of licenses of the applications.

At present, printers can be roughly categorized into a network printer that is connected to a network and obtains print data from the network to print; a local printer that is directly connected to a local terminal such as a PC and obtains print data from the local terminal to print; and an off-line printer that obtains print data without involving the network from a given memory medium to print.

When a network printer and local printer are constituted as a customized printer, at a server or local terminal, the application distribution and license management can be relatively easily carried out. On the other hand, when an off-line printer is constituted as a customized printer, it is difficult to carry out the application distribution and license management. This is because the concept of the off-line printer is in that without the network connection environment or local terminal, only insertion of a memory medium of such as a digital camera and so on readily allows printing. That is, different from the network printer and local printer, a method of connecting to an external server or the PC is not preferably adopted.

So far, as a technique of managing licenses of applications, an information processor described in, for instance, JP-A No. 2003-228536 is disclosed. The invention described in JP-A No. 2003-228536 discloses a transmitter-receiver that transmits and receives data; an input device for operating operations; a memory device that memorizes data and so on; a controller that processes data for controlling an overall device; and a server confirmation function that when connection with a server device that has a transmitter-receiver is confirmed and the connection is established a program received at the memory device is executed.

In the invention described in JP-A No. 2003-228536, when an information processor can confirm the connection with a server, an application is allowed to execute, and thereby the licenses of the applications are managed.

On the other hand, when an off-line printer is constituted as a customized printer, it is assumed that a plurality of kinds of applications is designed and licenses of the applications are separately managed. Accordingly, even when a wireless communication function such as infrared communication function is added to the off-line printer and the license management method described in JP-A No. 2003-228536 is applied, there is a problem in that the licenses of the applications cannot be separately managed.

Such a problem is similarly assumed to, without restricting to the off-line printers, all devices that are said preferable to use without establishing a connection environment with the network and local terminal.

### SUMMARY

In this connection, the invention was carried out by paying attention to an unsolved problem that an existing technology has and intends to provide an application management system suitable for performing application distribution and license management without establishing a connection environment with networks and local terminals and managing licenses of a plurality of applications separately; a device with application execution function; a portable terminal with application management function; a device program; a program and memory medium for the portable terminal, and an application management method.

An application management system according to an embodiment of this invention includes: an application management system that communicably connects a device that executes an application and a portable terminal that manages the application, and thereby manages the application; the portable terminal including an application memory unit that correlates and memorizes license information for certifying the eligibility for use of the application and the application; an application distribution unit that distributes the application and license information corresponding thereto of the application memory unit to the device; and license certification unit that certifies the eligibility for use of the application; and the device including an application receiving unit that receives the application and the license information; a license confirmation unit that confirms based on the license information the portable terminal the eligibility for use of the application; and an application execution unit that executes the application; the license confirmation unit, when sending the license information received at the application receiving unit together with a confirmation request to the portable terminal, and receiving a certification judgment result of the eligibility for use of the application, based on the received certification judgment result, makes the application received at the application receiving unit executable at the application execution unit; and the license certification unit, when receiving the confirmation request and the license information, based on the received license information, judging whether it has the eligibility for use of application or not, and sending certification judgment result thereof to the device.

In such a configuration, in the case of an application being distributed, at the portable terminal, by use of the application distribution unit, an application and license information corresponding thereto in the application memory unit are distributed to the device.

At the device, when the application receiving unit receives the application and the license information, the application becomes executable.

In the next place, when the application is executed, at the device, the license confirmation unit sends the received license information and a confirmation request thereof to the portable terminal.

The portable terminal, when the license certification unit receives the confirmation request and the license information, based on the received license information, judges whether it has the eligibility for use of application or not, and sends the certification judgment result to the device.

The device, when receiving the certification judgment result, by use of the license confirmation unit, based on the received certification judgment results, makes the received application executable by the application execution unit. When the application is rendered executable, the application execution unit executes the received application.

Thereby, the distribution of the applications and management of the licenses are performed at the portable terminal; accordingly, there is an effect in that without establishing a connection environment with the network and the local terminal on the device side, applications can be distributed and licenses can be managed. Furthermore, there is another advantage in that the applications and license information are managed correlated; accordingly, licenses of a plurality of applications can be separately managed.

Here, the application memory unit is one that memorizes applications and license information by all means and at all times, and may be one that memorizes the applications or license information beforehand, or one that, without memorizing the applications or license information beforehand, when the system is operated, memorizes the applications or license information by inputting externally. This is same also in a portable terminal with application management function according to the embodiment below.

Furthermore, in the application memory unit, applications and license information may be memorized in a correlated manner, for instance, at least piece of license information may be correlated with one application or at least one application may be correlated with one license information.

Furthermore, it is preferable that in the application management system according an embodiment of the invention, the device is an off-line printer that obtains print data not through the network but from a memory medium to print.

In such a configuration, with the off-line printer as a target, an application can be distributed and a license can be managed.

Thereby, an effect can be obtained in that without establishing a connection environment with the network and the local terminal on the off-line printer side, applications can be distributed and licenses can be managed.

Still furthermore, it is preferable that in the application management system according an embodiment of the invention, the license confirmation unit, when the certification judgment result judges that the eligibility for use of the application is denied or that communication with the portable terminal is impossible, restricts the execution of the application.

In such a configuration, at the off-line printer, when the certification judgment result judges that the eligibility for use of the application is denied or that communication with the portable terminal is impossible, the license confirmation unit restricts the execution of the application.

Thereby, when a result that denies the eligibility for use of the application is received from the portable terminal or communication with the portable terminal is impossible, the execution of the application is restricted; accordingly, there is an effect in that the likelihood of the application being used outside of the license can be reduced.

Here, the license confirmation unit, as far as it can restrict the execution of the application, may be constituted anyway. For instance, the application may be restricted from executing (does not start), (by designating by a start option of the application) a function of the application may be restricted, or (by setting the execution priority low) an execution speed of the application may be restricted.

Furthermore, as a period of restriction, for instance, when the license confirmation is performed each time when the application starts, a period from the start of the application to a termination time is considered; when the license confirmation is applied at an optional timing, a period from a previous license confirmation time to a next license confirmation time; and when the license confirmation is applied only at a time when the application is used for the first time (a case where until the eligibility for use of the application is certificated, the eligibility for use of the application is confirmed when the application is started-up), a period from a time of first certification of the eligibility for use to the shut-down of a power source of the device.

Furthermore, it is preferable that in the application management system according to an embodiment of the invention, the license confirmation unit, until the eligibility for use of the application is certified, confirms the portable terminal the eligibility for use of the application received by the application receiving unit at a time when the application is started-up.

In such a configuration, at the off-line printer, the license confirmation unit, until the eligibility for use of the application is certified, confirms the portable terminal the eligibility for use of the received application at the start-up time thereof.

Thereby, an effect of reducing the number of times and an amount of communication with the portable terminal can be obtained. Furthermore, an application of which eligibility for use is once confirmed can be executed thereafter without confirmation; accordingly, there is an effect in that the convenience of the application can be improved.

Furthermore, it is preferable that in the application management system according to an embodiment of the invention, the portable terminal has an accounting unit that, when the application distribution unit distributes the application or when the license certification unit certifies the eligibility for use of the application, executes an accounting process to the utilization of the application.

In such a configuration, at the portable terminal, when the application is distributed or when the eligibility for use of the application is certified, the accounting unit executes the accounting process to utilization of the application.

Thereby, an effect that relatively proper accounting can be performed to the utilization of the application.

Still furthermore, according to an embodiment of the invention, an application management system is an application management system that communicably connects a device that executes an application and a portable terminal that manages the application and thereby manages the application; the portable terminal including a license information memory unit that correlates license information for certifying the eligibility for use of the application with the application to memorize; an application distribution unit that distributes the application and license information of the license information memory unit corresponding to the application to the device; and license certification unit that certifies the eligibility for use of the application; and the device including an application receiving unit that receives the application and the license information; a license confirmation unit that confirms based on the license information the portable terminal the eligibility for use of the application; and an application execution unit that executes the application; the license confirmation unit, when sending the license information received at the application receiving unit together with a confirmation request to the portable terminal and receiving a certification judgment result of the eligibility for use of the application, based on the received certification judgment result, makes the application received at the application receiving unit executable at the application execution unit; and the license certification unit, when receiving the confirmation request and the license information, based on the received license information, judging whether it has the eligibility for use of application or not, and sending the certification judgment result to the device.

Here, the license information memory unit is one that memorizes license information by all means and at all times, and may be one that memorizes the license information beforehand or one that, without memorizing the license information beforehand, when the system operates, memorizes the license information by inputting externally.

Furthermore, the license information memory unit, as far as it memorizes the license information correlated with the application, may not necessarily memorize the application. When the application is not memorized, it may be memorized correlated with reference information such as an identifier or a link of the application. Furthermore, for instance, at least one piece of license information may be correlated with one application or at least one application may be correlated with one license information.

On the other hand, in order to achieve the above advantages, according to an embodiment of the invention, a device with application execution function is a device with application execution function that executes an application, including; an application receiving unit that receives the application and license information for certifying the eligibility for use of the application; a license confirmation unit that based on the license information confirms an external terminal the eligibility for use of the application; and an application execution unit that executes the application, the license confirmation unit, when sending the license information received at the application receiving unit together with a confirmation request to the external terminal and receiving a certification judgment result of the eligibility for use of the application, based on the received certification judgment result, makes the application received at the application receiving unit executable at the application execution unit.

Furthermore, it is preferable that in the device with an application execution function according to an embodiment of the invention, the device is an off-line printer that obtains print data not through the network but from a memory medium and prints.

Still furthermore, it is preferable that in the device with an application execution function according embodiments of the invention, the license confirmation unit, when judging that the certification judgment result denies the eligibility for use of the application or that communication with the external terminal is impossible, restricts the execution of the application.

Furthermore, it is preferable that in the device with an application execution function according to embodiments of the invention, the license confirmation unit, until the eligibility for use of the application is certified, confirms the external terminal the eligibility for use of the application received by the application receiving unit at a time when the application is started up.

On the other hand, in order to achieve the advantage, according to an embodiment of the invention, a portable terminal with an application management function is a portable terminal with an application management function that manages an application, including: an application memory unit that correlates license information for certifying the eligibility for use of the application and the application and memorizes; an application distribution unit that distributes the application of the application memory unit and license information corresponding thereto to the device; and license certification unit that certifies the eligibility for use of the application; the license certification unit, when receiving the confirmation request and the license information, based on the received license information, judging whether it has the eligibility for use of application or not, and sending the certification judgment result to the device.

Furthermore, it is preferable that the portable terminal with an application management function according to an embodiment of the invention, includes: an accounting unit that, when the application is distributed by the application distribution unit, or when the license certification unit certifies the eligibility for use of the application by the license certification unit, carries out an accounting process to the use of the application.

Still furthermore, according to an embodiment of the invention, a portable terminal with an application management function is a portable terminal with an application management function that manages an application, including: a license information memory unit that correlates license information for certifying the eligibility for use of the application and the application and memorizes; an application distribution unit that distributes the application and license information of the license information memory unit corresponding thereto to the device; and license certification unit that certifies the eligibility for use of the application; the license certification unit, when receiving the confirmation request and the license information, based on the received license information, judging whether it has the eligibility for use of application or not, and sending the certification judgment result to the device.

On the other hand, in order to achieve the above advantage, according to an embodiment of the invention, a device program is a device program that makes a computer that operates as a device that executes an application execute, including: a program that makes the computer execute a process made of an application receiving step that receives the application and license information for certifying the eligibility for use of the application; a license confirmation step for confirming based on the license information an external terminal the eligibility for use of the application; and an application execution step that executes the application; the license confirmation step sending the license information received at the application receiving step together with a confirmation request to the external terminal, and when receiving a certification judgment result of the eligibility for use of the application, based on the received certification judgment result, making the application received at the application receiving step executable.

Furthermore, it is preferable that in the device program according an embodiment of the invention, the computer is an off-line printer that obtains print data not through the network but from a memory medium and prints.

Still furthermore, it is preferable that in the device program according to embodiments of the invention, the license confirmation step, when the certification judgment result judges that the eligibility for use of the application is denied or that communication with the external terminal is impossible, restricts the execution of the application.

Here, the license confirmation step, as far as it can restrict the execution of the application, may be constituted anyway. For instance, the application may be restricted from executing (doe not start), (by designating by a start option of the application) a function of the application may be restricted, or (by setting the execution priority low) an execution speed of the application may be restricted.

Furthermore, it is preferable that in the device program according to embodiments of the invention, the license confirmation step, until the eligibility for use of the application is certified, confirms the external terminal the eligibility for use of the application received at the application receiving step at the start-up time of the application.

On the other hand, in order to achieve the above advantage, according an embodiment of the invention, a program for portable terminal is a program for portable terminal that makes a computer that operates as a portable terminal that manages an application execute; the computer being capable of using an application memory unit that memorizes license information for certifying the eligibility for use of the application correlated with the application, including: a program that makes the computer execute a process including an application distribution step for distributing the application of the application memory unit and the license information corresponding thereto to a device and a license certification step for certifying the eligibility for use of the application; the license certification step, when receiving confirmation request and the license information, based on the received license information, judging whether it has the eligibility for use of the application or not, and sending the certification judgment result to the device.

Furthermore, it is preferable that the program for portable terminal according an embodiment of the invention, includes: a program that when the application is distributed at the application distribution step, or when the license certification step certifies the eligibility for use of the application, makes the computer to execute a process made of a accounting step that execute accounting process to the use of the application.

Still furthermore, according to an embodiment of the invention, a program for portable terminal is a program for portable terminal that makes a computer that operates as a portable terminal that manages an application execute; the computer being capable of using a license information memory unit that memorizes license information for certifying the eligibility for use of the application correlated with the application; and includes a program that makes the computer execute a process made of an application distribution step for distributing the application and license information of the license information memory unit corresponding thereto and a license certification step for certifying the eligibility for use of the application; the license certification step, when receiving the license information together with confirmation request, based on the received information, judging whether it is eligible for use of the application or not, and sending the certification judgment result to the device.

On the other hand, according to embodiment of the invention, a memory medium is a computer readable memory medium that memorizes a program for device that makes a computer that operates as a device that executes an application execute; memorizes a program that makes the computer execute a process including an application receiving step that receives the application and license information for certifying the eligibility for use of application; a license confirmation step that confirms based on the license information an external terminal the eligibility for use of the application; and an application execution process that executes the application; wherein the license confirmation step, when sending license information received at the application receiving step together with a confirmation request to the external terminal and receiving certification judgment result of the eligibility for use of application, based on the received certification judgment result, makes an application received at the application receiving step executable.

Furthermore, it is preferable that in the memory medium of the invention, the computer is an off-line printer that obtains print data not through a network but from a memory medium.

Still furthermore, it is preferable that in the memory medium, the license confirmation step, when the certification judgment result judges that the eligibility for use of application is denied or that communication with the external terminal is impossible, restricts the application from being executed.

Furthermore, it is preferable that in the memory medium according the invention, the license confirmation step, until the eligibility for use of the application is certified, confirms, at the start-up of the application, the external terminal the eligibility for use of application received at the application receiving step.

Still furthermore, according to the invention, a memory medium is a computer readable memory medium that memorizes a program for portable terminal that makes a computer that operates as a portable terminal that manages an application execute; the computer being made usable an application memory unit that memorizes license information for certifying the eligibility for use of application correlated with the application; and memorizes a program that makes the computer execute a process made of an application distribution step that distributes an application of the application memory unit and license information correlated therewith and a license certification step that certifies the eligibility for use of application; the license certification step, when receiving confirmation request and the license information, based on the received license information, judging whether it has the eligibility for use of application, and sending the certification judgment result to the device.

Furthermore, it is preferable that the memory medium according the invention memorizes a program that when the application is distributed at the application distribution step, or when the license certification step certifies the eligibility for use of the application, makes the computer execute a process made of a accounting step that executes an accounting process to the use of the application.

Still furthermore, according the invention, a memory medium is a computer readable memory medium that memorizes a program for portable terminal that makes a computer that operates as a portable terminal that manages an application execute; the computer being capable of using a license information memory unit that memorizes license information for certifying the eligibility for use of application correlated with the application; and memorizes a program that makes the computer execute a process made of an application distribution step that distributes the application and license information of the license information memory unit corresponding thereto and a license certification step that certifies the eligibility for use of application; the license certification step, when receiving the confirmation request and the license information, based on the received license information, judging whether it has the eligibility for use of application, and sending the certification judgment result to the device.

An application management method according to an embodiment of the invention is an application management method that communicably connects a device that executes an application and a portable terminal that manages the application and thereby manages the application, and includes: to the portable terminal, an application distribution step that reads the application and license information corresponding thereto from an application memory unit that memorizes license information for certifying the eligibility for use of application correlated with the application and distributes read application and license information to the device; to the device, an application receiving step that receives the application and the license information; and a first license confirmation step that sends license information received at the application receiving step and confirmation request to the portable terminal; to the portable terminal, a license certification step that, at the reception of the confirmation request and the license information, based on the received license information, judges whether it has the eligibility for use of application or not, and sends the certification judgment result to the device; and to the device, a second license confirmation step that, at the reception of the certification judgment result, based on the received certification judgment result, makes an application received at the application receiving step executable, and an application execution step that executes an application that is made executable at the second license confirmation step.

Furthermore, it is preferable that in the application management method that, the device is an off-line printer that obtains print data not through the network but from a memory medium to print.

Still furthermore, it is preferable that in the application management method according embodiments of the invention, the second license confirmation step, when the certification judgment result judges that the eligibility for use of application is denied or that the communication with the portable terminal is impossible, restricts executing the application.

Furthermore, it is preferable that in the application management method according to embodiments of the invention, the first and second license confirmation steps, until the eligibility for use of application is certified, confirm, at the start-up of the application, the portable terminal the eligibility for use of application received at the application receiving step.

Still furthermore, it is preferable that the application management method according to embodiments of the invention, including: to the portable terminal, an accounting step that, when the application is distributed at the application distribution step or the eligibility for use of application is certified at the license certification step, executes an accounting process to the use of the application.

Furthermore, according to an embodiment of the invention, an application management method is an application management method that communicably connects a device that executes an application and a portable terminal that manages the application and thereby manages the application, and includes: to the portable terminal, an application distribution step that reads license information corresponding to the application from a license information memory unit that memorizes license information for certifying the eligibility for use of application correlated with the application and distributes the application and read license information to the device; to the device, an application receiving step that receives the application and the license information, and a first license confirmation step that sends license information received at the application receiving step and confirmation request to the portable terminal; to the portable terminal, a license certification step that, at the reception of the confirmation request and the license information, based on the received license information, judges whether it has the eligibility for use of application or not, and sends the certification judgment result to the device; and to the device, a second license confirmation step that, at the reception of the certification judgment result, based on the received certification judgment result, makes the application received at the application receiving step executable; and an application execution step that executes an application that is made executable at the second license confirmation step.

### BRIEF DESCRIPTION OF THE DRAWINGS

The invention will be described with reference to the accompanying drawings, wherein like numbers reference like elements, and wherein:

FIG. 1 is a functional block diagram showing a function outline of an application management system to which the invention is applied;

FIG. 2 is a block diagram showing a hardware configuration of a portable terminal 200;

FIG. 3 is a diagram showing a data structure of license information;

FIG. 4 is a diagram showing a data structure of an account information registration table 420;

FIG. 5 is a flowchart showing an application acquisition process;

FIG. 6 is a flowchart showing an application distribution process;

FIG. 7 is a flowchart showing a license certification process;

FIG. 8 is a block diagram showing a hardware configuration of an off-line printer 300;

FIG. 9 is a flowchart showing an application registration process;

FIG. 10 is a flowchart showing an application execution process;

FIG. 11 is a diagram showing license information of a printing/explanation application;

FIG. 12 is a diagram showing license information of a printing supervision application;

FIG. 13 is a diagram showing license information of numbered ticket printing application;

FIG. 14 is a diagram showing license information of a coupon printing application;

FIG. 15 is a diagram showing license information of a portable printing application; and

FIG. 16 is a diagram showing a memory medium and a data structure thereof.

### DESCRIPTION OF THE EMBODIMENTS

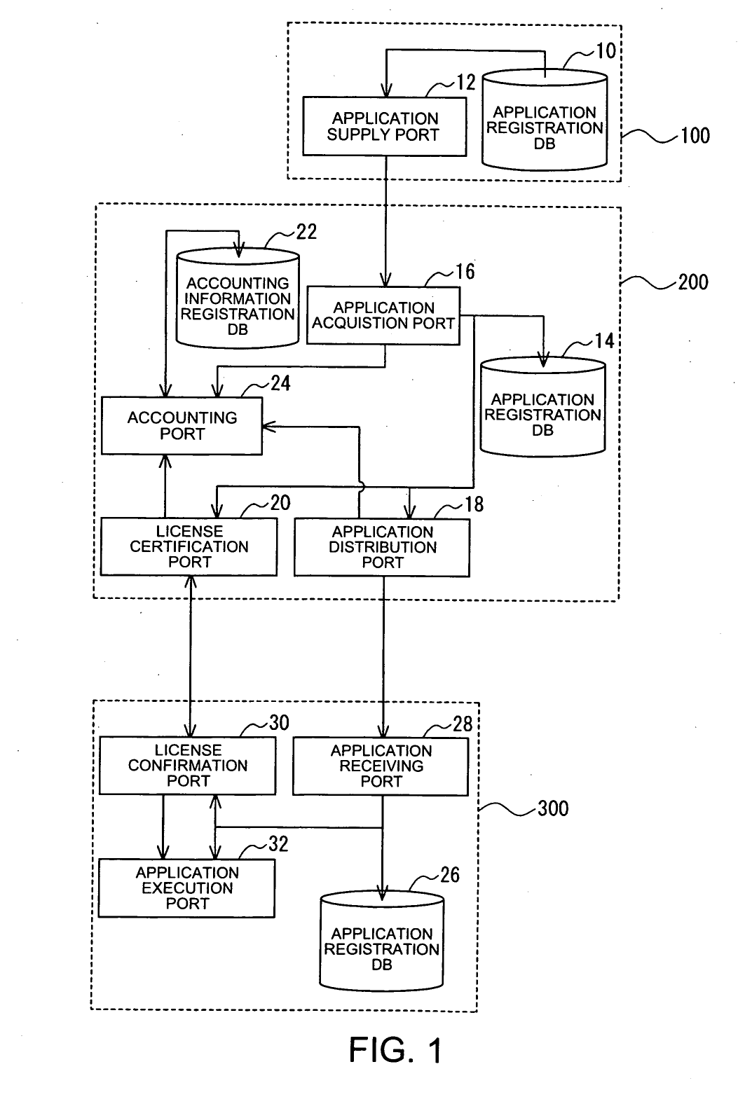

In what follows, embodiments according to the invention will be described with reference to the drawings. FIGS. 1 through 15 are diagrams showing embodiments of an application management system, a device with application execution function, a portable terminal with application management function, a device program, a program for portable terminal and memory medium and an application management method according to the invention.

In the present embodiment, as shown in FIG. 1, an application management system, a device with application execution function, a portable terminal with application management function, a device program, a program for portable terminal and a memory medium and an application management method according to the invention are applied to a case where an application of an off-line printer 300 is managed.

At the beginning, a function outline of an application management system to which the invention is applied will be described with reference to FIG. 1.

FIG. 1 is a block diagram showing a function outline of the application management system to which the invention is applied.

An application management system includes, as shown in FIG. 1, an off-line printer 300 that obtains print data not through a network but from a given memory medium to print; an application management server 100 that manages an application of the off-line printer 300; and a portable terminal 200 that is supplied for use of a user of the off-line printer 300. The portable terminal 200 can be communicably connected with the application management server 100 and the off-line printer 300.

The application management server 100 includes, as shown in FIG. 1, an application registration database where license information for certifying the eligibility for use of application for each application is registered correlated with the application (hereinafter, simply abbreviated as DB) 10; and an application supply port 12 that in response to an acquisition request from the portable terminal 200 supplies an application of the application registration DB 10 and license information corresponding thereto to the portable terminal 200.

The portable terminal 200 includes, as shown in FIG. 1, an application registration DB 14 thereto an application is registered; and an application acquisition port 16 that acquires an application from the application management server 100.

The application acquisition port 16 acquires an application and license information from the application management server 100 and acquired application and license information are correlated and registered in the application registration DB 14.

The portable terminal 200 further includes an application distribution port 18 that distributes an application and license information corresponding thereto of the application registration DB 14 to the off-line printer 300; and a license certification port 20 that in accordance with confirmation request from the off-line printer 300 certifies the eligibility for use of application.

The license certification port 20, when receiving the confirmation request and license information, based on the received license information, judges whether it has the eligibility for use of application or not, and sends, as the certification judgment result, certification response or denial response to the off-printer 300.

The portable terminal 200 further has an accounting information registration DB 22 where accounting information concerning accounting is registered; and an accounting port 24 that carries out an accounting process based on accounting information of the accounting information registration DB 22 to the use of the application.

The off-line printer 300 includes, as shown in FIG. 1, an application registration DB 26 thereto an application is registered; an application receiving port 28 that receives the application and license information; a license confirmation port 30 that confirms the portable terminal 200, based on the license information, the eligibility for use of application; and an application execution port 32 that executes the application.

The application receiving port 28 receives an application and license information and correlates the received application and license information to register in the application registration DB 26.

The license confirmation port 30 reads license information corresponding to an application that is a target of execution (hereinafter, referred to as application to be executed) from the application registration DB 26, sends the read license information together with confirmation request to the portable terminal 200, and, when receiving the certification judgment result, based on the received certification judgment result, allows executing the application.

The application execution port 32, when the license confirmation port 30 allows executing an application to be executed, executes the application.

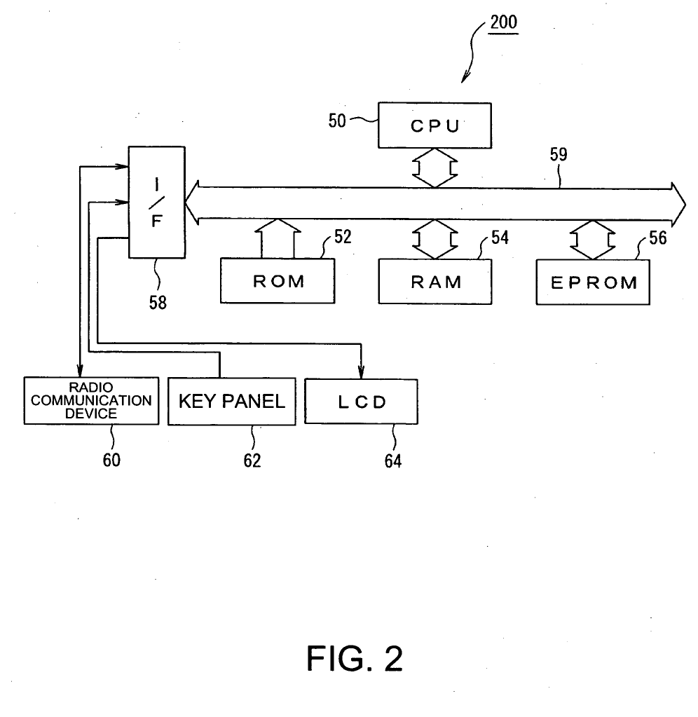

In the next place, a configuration of the portable terminal 200 will be detailed with reference to FIGS. 2 through 7.

FIG. 2 is a block diagram showing a hardware configuration of the portable terminal 200.

The portable terminal 200 includes, as shown in FIG. 2, a CPU 50 that controls based on a control program calculations and a whole system; a ROM 52 that beforehand stores a control program of the CPU 50 and so on in a predetermined region; a RAM 54 that stores data read from the ROM 52 and so on and calculation results necessary in the course of calculations; an EPROM 56 that stores information that is necessary to hold involatile such as application and others; and an I/F 58 that interfaces input/output of data to an external device. These are mutually and data transferably connected via a bus 59 that is a signal line for transferring data.

To the I/F 58, a radio communication device 60 that performs radio communication with the application management server 100 and the off-line printer 300, a key panel 62 capable of inputting data with a plurality of keys as a human interface, and a LCD (Liquid Crystal Display) 64 that displays image screens based on image signals are connected.

The EPROM 56 constitutes the application registration DB 14 and the accounting information registration DB 22.

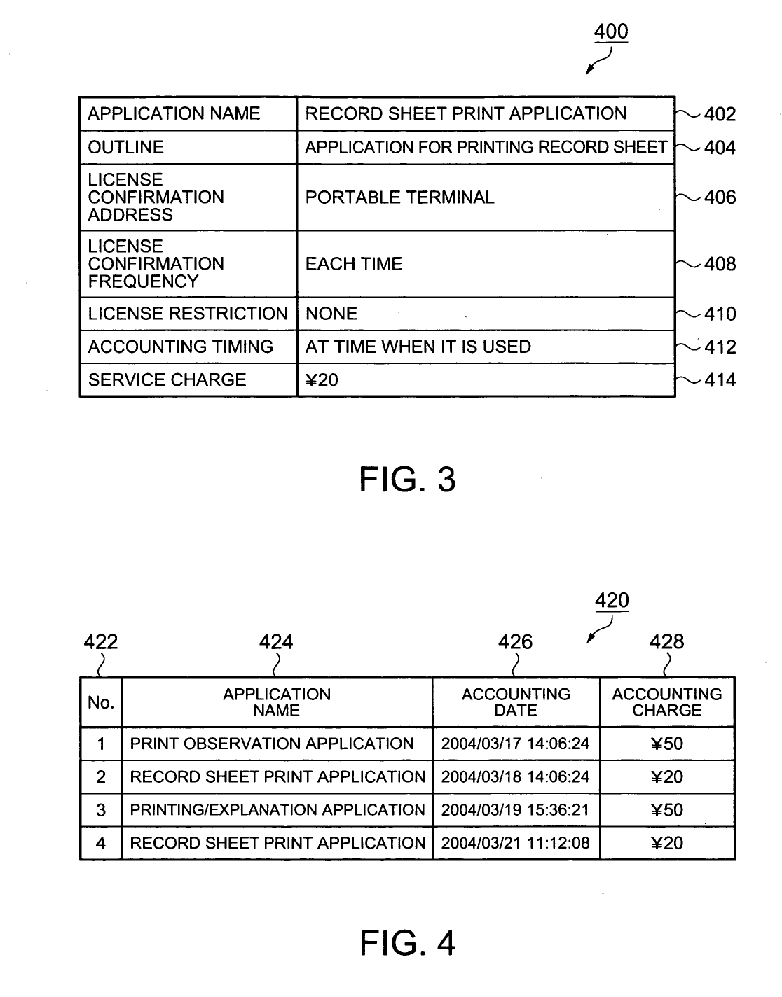

FIG. 3 is a diagram showing a data structure of license information.

In the EPROM 56, for each application, license information is registered. The license information 400 includes, as shown in FIG. 3, a field 402 where names of applications are registered; a field 404 where outline explanations of the applications are registered; a field 406 where license confirmation addresses that show addresses where to confirm the eligibility for use of application are registered; and a field 408 where license confirmation frequencies that show the frequencies of confirmation of the eligibility for use of application are registered. Furthermore, a field 410 where license restrictions that show particular restrictions of the eligibility for use of applications are registered, a field 412 where accounting timings that show timings of accounting process to the use of the applications are registered and a field 414 where service charges that show prices to the use of the applications are registered.

In the field 406, as a license confirmation address, any one of the portable terminal 200 and off-line printer 300 is registered. In an example shown in FIG. 3, a “portable terminal” is registered. This shows that the eligibility for use of application is certified at the portable terminal 200.

In the field 408, as the license confirmation frequency, any one of confirming each time when the application is used and of confirming only at the start-up time of the application (This means that until the eligibility for use of application is certified, the eligibility for use of application is confirmed at the time of start-up of the application. The same shall apply hereinafter.) is registered. In an example shown in FIG. 3, “each time” is registered. This means that each time when the application is used, the eligibility for use of application is confirmed.

In the field 410, as the license restriction, any one of the number of times of use, a usable period and no restriction is registered. In an example shown in FIG. 3, “no restriction” is registered. This shows that there is no particular restriction on the eligibility for use of application.

In the field 412, as the accounting timing, any one of a time when an application is acquired from the application management server 100 (hereinafter, referred to as the application acquisition time), a time when an application is distributed from the portable terminal 200 (hereinafter, referred to as the application distribution), a time when the eligibility for use of application is certified (hereinafter referred to as the application certification time) and no designation is registered. In an example shown in FIG. 3, “at the time of use” is registered.

FIG. 4 is a diagram showing a data structure of an accounting information registration table 420.

In the EPROM 56, an accounting information registration table 420 that registers accounting information is registered.

In the accounting information registration table 420, as shown in FIG. 4, one record is registered for each accounting process. Each record includes a field 422 where a serial number is registered, a field 424 where a name of an application that is a target of accounting is registered, a field 426 where an accounting date when the accounting process is carried out is registered and a field 428 where an accounting fee is registered.

In an example shown in FIG. 4, in a record in a first stage, “1” is registered as the serial number; “printing observation application”, as the application name; “2004/03/17 14:06:24”, as the accounting date; and “¥50”, as the accounting fee. This shows that to the use of the printing observation application, at “2004/03/17 14:06:24”, “¥50” is charged.

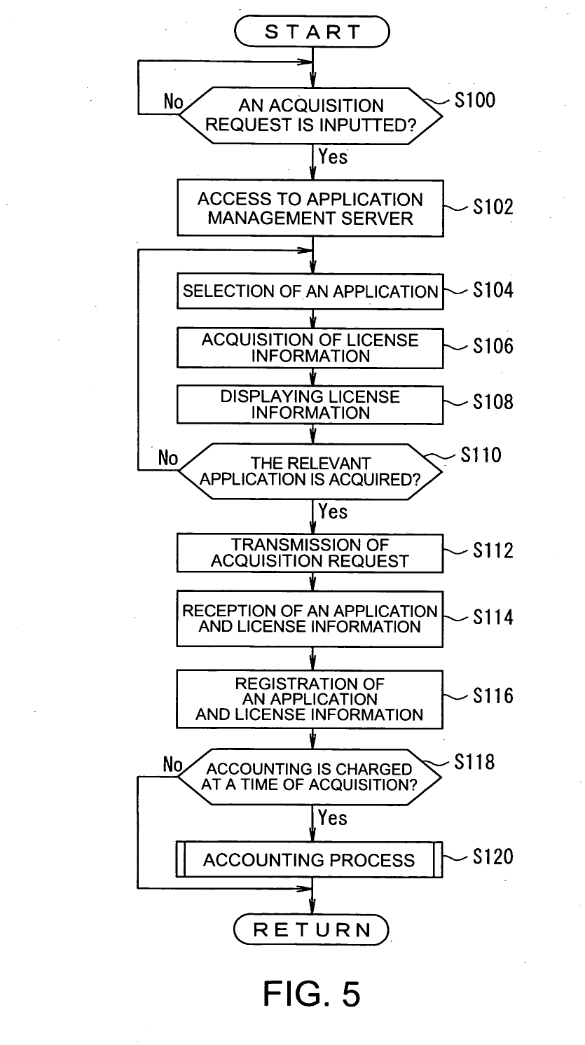

Returning to FIG. 2, the CPU 50 is made of a micro-processing unit (MPU) and so on, starts up a predetermined program stored in a predetermined region of the ROM 52, and, according to the program, executes an application acquisition process, an application distribution process and a license certification process shown in flowcharts in FIGS. 5 through 7 in a time-sharing manner.

In the beginning, an application acquisition process will be detailed with reference to FIG. 5.

FIG. 5 is a flowchart showing an application acquisition process.

The application acquisition process is a process that is realized as an application acquisition port 16 and an accounting port 24, and, when it is executed at the CPU 50, as shown in FIG. 5, the first step proceeds to step S100.

In the step S100, whether an application acquisition request is inputted from a key panel 62 or not is judged. When the application acquisition request is judged inputted (Yes), followed by proceeding to S102, but, when it is not so (No), the process stays at the step S100 until the application acquisition request is received.

In the step S102, the application management server 100 is accessed, followed by proceeding to step S104, the application management server 100 displays a list of registered applications on the LCD 64 and shows on the LCD 64 that an application that is a target of acquisition should be selected from the list, a selection of an application is inputted from the key panel 62, followed by proceeding to step S106.

In the step S106, license information corresponding to the selected application is acquired from application management server 100, followed by proceeding to step S108, based on the acquired license information a content of the license information is displayed on the LCD 64, followed by proceeding to step S110.

In the step S110, whether a confirmation of acquisition of the selected application is inputted from the key panel 62 or not is judged. When the confirmation for acquisition of the selected application is judged inputted (Yes), followed by proceeding to step S112, an acquisition request of the selected application is transmitted to the application management server 100, followed by proceeding to S114.

In the step S114, the application and the license information are received, followed by proceeding to step S116, the received application and license information are registered in the EPROM 56, followed by proceeding to step S118.

In the step S118, an accounting timing is extracted from the received license information, whether the obtained accounting timing is a time when the application is acquired or not is judged. When the accounting timing is judged a time when the application is acquired (Yes), followed by proceeding to step S120.

In the step S120, an application name and a service charge are extracted from the received license information, the extracted application name and service charge, and a serial number and the time are registered as a new record of the accounting information registration table 420, and thereby a series of processes comes to completion, followed by returning to the original process. In the accounting information registration table 420 is sent to, for instance, a management company of the portable terminal 200, and an accounting fee of the application is combined with a call rate of the portable terminal 200 and charged to a user.

On the other hand, in the step S118, when the accounting timing is judged not a time when the application is acquired (No), a series of processes comes to completion, followed by returning to an original process.

On the other hand, in the step S110, when the confirmation of the acquisition of the selected application is judged not inputted (No), followed by proceeding to step S104.

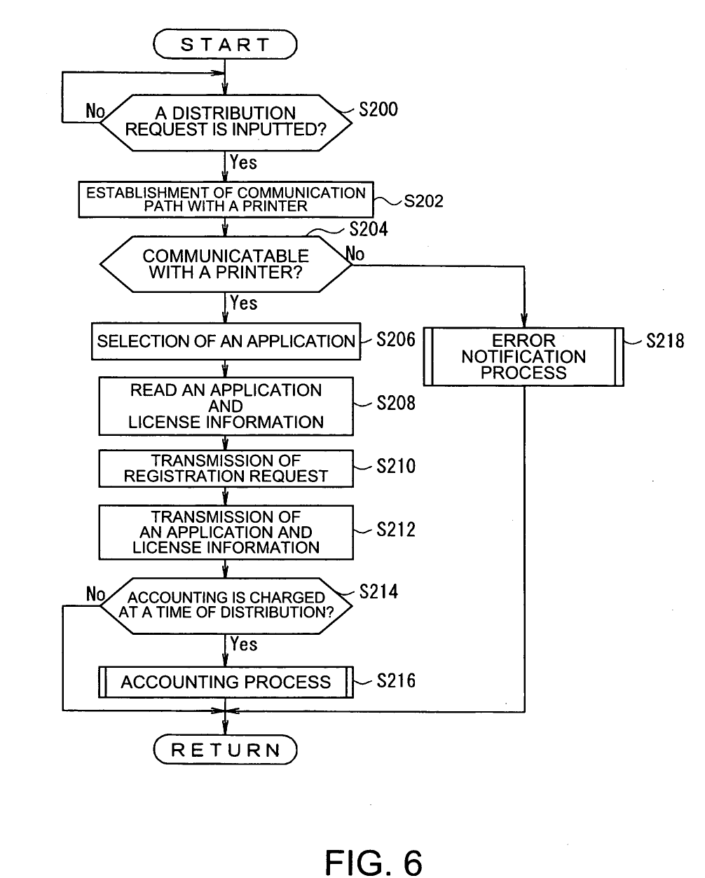

In the next place, an application distribution process will be detailed with reference to FIG. 6.

FIG. 6 is a flowchart showing an application distribution process.

The application distribution process is a process realized as an application distribution port 18 and an accounting port 24. When it is executed at the CPU 50, as shown in FIG. 6, the first step begins with step S200.

In the step S200, whether an application distribution request is inputted from the key panel 62 or not is judged; when the application distribution request is judged inputted (Yes), followed by proceeding to step S202, when it is not so (No), until the application distribution request is received, the process stays at the step S200.

In the step S202, the radio communication device 60 establishes a radio communication path with the off-line printer 300, followed by proceeding to step S204; whether communication is possible with the off-line printer 300 or not is judged, when the communication with the off-line printer 300 is judged possible (Yes), followed by proceeding to step S206.

In the step S206, a list of applications registered in the EPROM 56 is displayed on the LCD 64 and that from the list an application that is a subject to be distributed should be selected is displayed on the LCD 64, selection of the application is inputted from the key panel 62, followed by proceeding to step S208.

In the step S208, the selected application and license information corresponding thereto are read from the EPROM 56, followed by proceeding to step S210, a registration request of the application is transmitted to the off-line printer 300, followed by proceeding to step S212, the read application and license information are transmitted to the off-line printer 300, followed by proceeding to step S214.

In the step S214, an accounting timing is extracted from the read license information; whether the extracted accounting timing is a time when the application is distributed or not is judged; when the accounting timing is judged a time when the application is distributed (Yes), followed by proceeding to step S216.

In the step S216, from the read license information, an application name and a service charge are extracted, the extracted application name and service charge, and a serial number and the time are registered as new record in the accounting information table 420, and thereby a series of processes comes to completion, followed by returning to an original process.

On the other hand, in the step S214, when the accounting timing is judged not a time when the application is distributed (No), a series of processes comes to completion followed by returning to an original process.

On the other hand, in the step S204, when the communication with the off-line printer 300 is judged impossible (No), followed by proceeding to step S218, an error notification process that displays on the LCD 64 a statement to the effect that the application cannot be distributed is carried out, a series of processes comes to completion followed by returning to an original process.

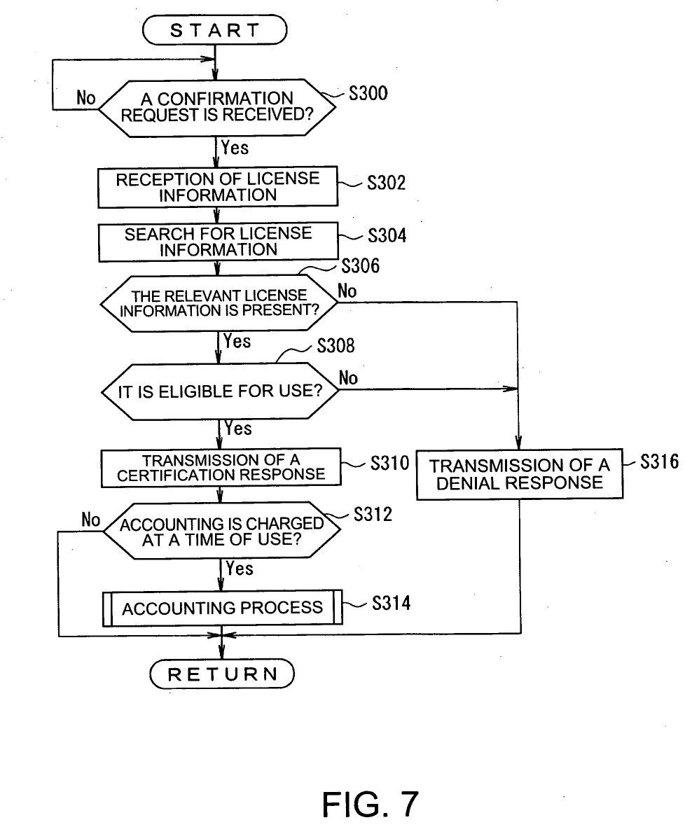

Subsequently, a license certification process will be detailed with reference to FIG. 7.

FIG. 7 is a flowchart showing a license certification process.

The license certification process is a process that is realized as a license certification port 20 and an accounting port 24. When it is executed at the CPU 50, as shown in FIG. 7, firstly, a process proceeds to step S300.

In the step S300, whether the license confirmation request is received or not is judged. When the license confirmation request is judged received (Yes), the process continues to step S302. When it is judged not so (No), until the license confirmation request is received the process stays at the step S300.

In the step S302, the license information is received, followed by proceeding to step S304, license information same as the received license information is searched from the EPROM 56, followed by proceeding to step S306, whether the relevant license information is present or not is judged, when the relevant license information is judged present (Yes), followed by proceeding to step S308.

In the step S308, from the received license information the license restriction is extracted, based on the extracted license restriction, whether it has the eligibility for use of application or not is judged, when it is judged eligible for use of the application (Yes), followed by proceeding to step S310, a certification response that shows that the eligibility for use of application is certified is sent to the off-line printer 300, followed by proceeding to step S312.

In the step S312, from the received license information the accounting timing is extracted, whether the extracted accounting timing is a time when the application is certified or not is judged, when the accounting timing is judged the time when the application is certified (Yes), followed by proceeding to step S314.

In the step S314, from the received license information the application name and service charge are extracted, the extracted application name and service charge, and the serial number and the time are registered as new record of the accounting information registration table 420, and thereby a series of processes comes to completion, followed by returning to the original process.

On the other hand, in the step S312, when the accounting timing is judged not a time when the application is certified (No), a series of processes comes to completion followed by returning to an original process.

On the other hand, in the step S308, when it is judged not eligible for use of the application (No), followed by proceeding to step S316, a denial response that shows that the eligibility for use of application is denied is sent the off-line printer 300, and thereby a series of processes comes to completion followed by returning to an original process.

On the other hand, in the step S306, when the relevant license information is judged as being not present (No), the process proceeds to the step S316.

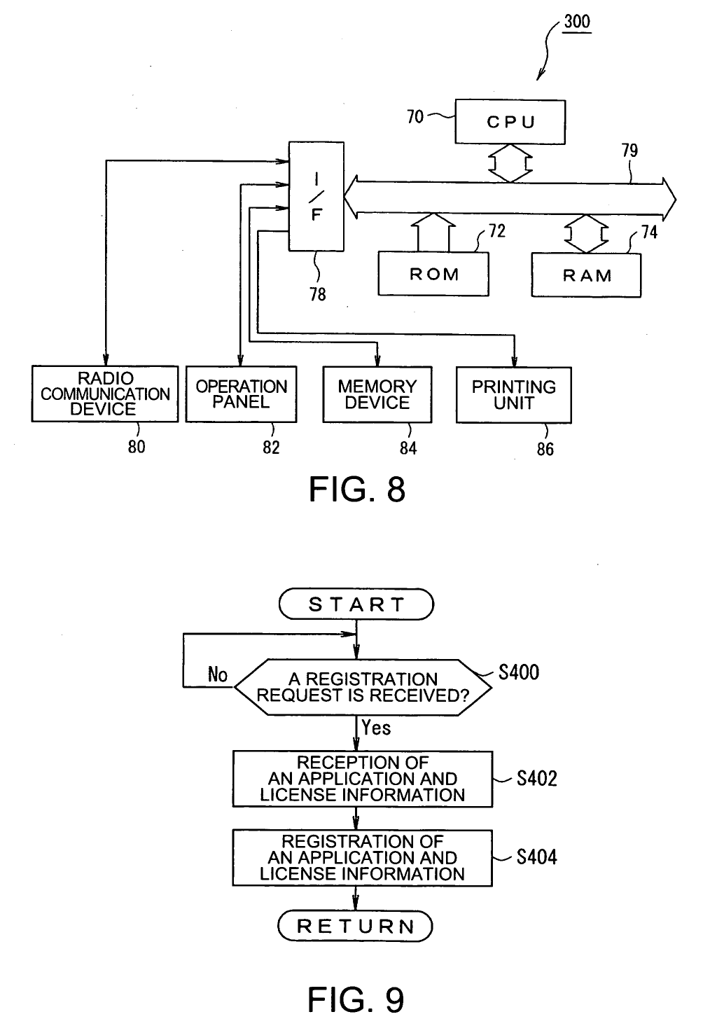

In the next place, a configuration of the off-line printer 300 will be detailed with reference to FIGS. 8 through 10.

FIG. 8 is a block diagram showing a hardware configuration of the off-line printer 300.

The off-line printer 300 includes, as shown in FIG. 8, a CPU 70 that controls calculations and an overall system based on a control program; a ROM 72 that beforehand stores the control program and so on of the CPU 70 in a predetermined region; a RAM 74 that stores data read from the ROM 72 and so on and calculation results necessary in the course of calculation of the CPU 70; and an I/F 78 that interfaces input/output of data to an external device. These are mutually data-transferably connected with buses 79 that are signal lines for transferring data.

To the I/F 78, a radio communication device 80 that performs radio communication with the portable terminal 200, an operation panel 82 made of a touch panel and so on capable of inputting and displaying data as a human interface, a memory device 84 that stores data and tables as files, and a print mechanism 86 that is made of a mechanism necessary for printing in accordance with a type of the off-line printer 300 such as an ink jet printer and a laser printer are connected.

The memory device 84 constitutes an application registration DB 26.

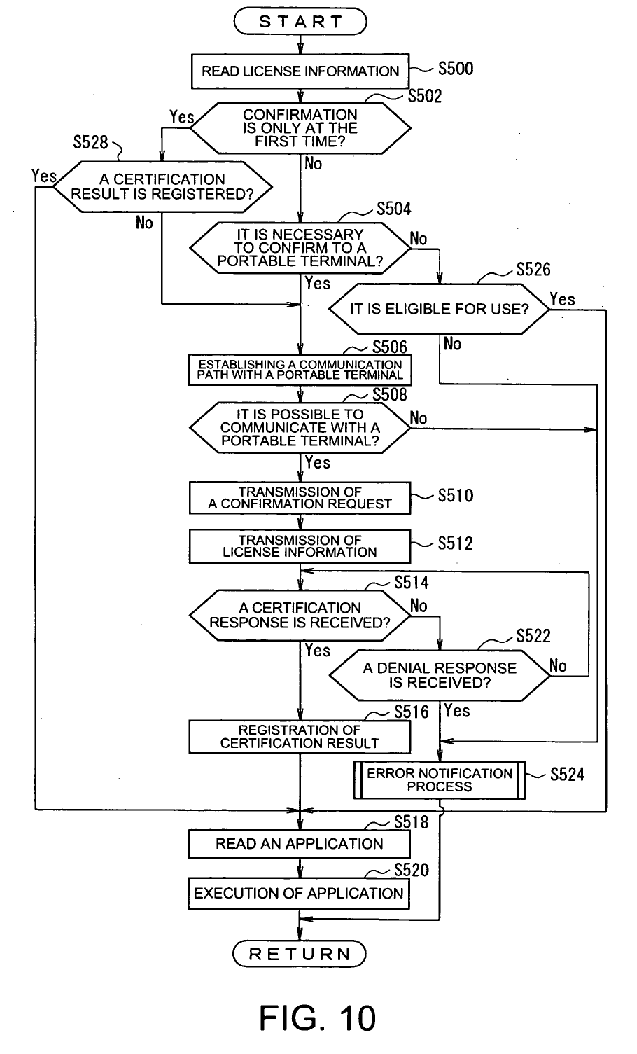

The CPU 70 is made of a micro-processing unit (MPU) and so on, starts up a predetermined program stored in a predetermined region of the ROM 72, and, in accordance with the program, executes in a time-sharing manner an application registration process and an application execution process that are shown in flowcharts of FIGS. 9 and 10.

At the beginning, an application registration process will be detailed with reference to FIG. 9.

FIG. 9 is a flowchart showing the application registration process.

The application registration process is a process that is realized as an application receiving port 28. When it is executed at the CPU 70, as shown in FIG. 9, firstly, a process proceeds to step S 400.

In the step S 400, whether an application registration request is received or not is judged. When the application registration request is judged received (Yes), followed by proceeding to step S402, and when it is judged not so (No), until the application registration request is received, the process waits at the step S400.

In the step S402, the application and license information are received, followed by proceeding to step S404, the received application and license information are registered in the memory device 84, and thereby a series of processes comes to completion, followed by returning to an original step.

In the next place, an application execution process will be detailed with reference to FIG. 10.

FIG. 10 is a flowchart showing an application execution process.

The application execution process is a process realized as a license confirmation port 30 and an application execution port 32 and initiated in accordance with an application execution request. When it is executed at the CPU 70, as shown in FIG. 10, firstly, a process proceeds to step S500.

In the step S500, license information corresponding to an application to be executed is read from a memory device 84, followed by proceeding to step S502, from the read license information a license confirmation frequency is extracted, whether the extracted license confirmation frequency shows that the confirmation is performed only at a time when the application is used for the first time or not is judged, and when it is judged that the license confirmation frequency does not show that the confirmation is performed only at a time when the application is used for the first time (No), step proceeds to step S504.

In the step S504, from the read license information, a license confirmation address is extracted, whether the extracted license confirmation address is a portable terminal 200 or not is judged, and when the license confirmation address is judged the portable terminal 200 (Yes), followed by proceeding to step S506.

In the step S506, by use of a radio communication device 80, a radio communication path with the portable terminal 200 is established, followed by proceeding to step S508, whether communication with the portable terminal 200 is possible or not is judged, and when the communication with the portable terminal 200 is judged possible (Yes), followed by proceeding to step S510.

In the step S510, a license confirmation request is transmitted to the portable terminal 200, followed by proceeding to step S512, the read license information is sent to the portable terminal 200, followed by proceeding to step S514.

In the step S514, whether the certification response is received or not is judged, when the certification response is judged received (Yes), followed by proceeding to step S516, a certification result that certifies the eligibility for use of application is correlated with the application to be executed and registered in the memory device 84, followed by proceeding to step S518.

In the step S518, the application to be executed is read from the memory device 84, followed by proceeding to step S520, the read application is executed, and thereby a series of processes comes to completion, followed by returning to an initial process.

On the other hand, in the step S514, when the certification response is judged as “not received” (No), followed by proceeding to step S522, whether a denial response is received or not is judged, when the denial response is judged received (Yes), followed by proceeding to step S524, an error notification process is carried out so as to display on the operation panel 82 a statement to the effect that the application cannot be executed, and thereby a series of processes comes to completion, followed by returning to an initial process.

On the other hand, in the step S522, when the denial response is judged not received (No), the process is followed by proceeding to step S514.

On the other hand, in the step S508, when the communication with the portable terminal 200 is judged impossible (No), the process is followed by proceeding to step S524.

On the other hand, in the step S504, when the license confirmation address is judged not as not necessary to confirm to the portable terminal 200 (No), the process is followed by proceeding to step S526., In step S526, from the read license information, the license restriction is extracted, on the basis of the read license information, it is determined whether the off line printer 300 has the eligibility for use of application or not. When it is eligible for use of the application (Yes), the process is followed by proceeding to step S518.

On the other hand, in the step S526, when it is judged not eligible for use of the application (No), the process is followed by proceeding to step S524.

On the other hand, in the step S502, when it is judged that the license confirmation frequency shows that the license confirmation is carried out only at a time when the application is used for the first time (Yes), followed by proceeding to step S528, whether the certification result of the application to be executed is registered in the memory device 84 or not is judged, when the certification result of the application to be executed is judged registered (Yes), followed by proceeding to step S518.

On the other hand, in the step S528, when the certification result of the application to be executed is judged not registered (No), followed by proceeding to step S506.

In the next place, an operation of the embodiment will be explained with reference to the drawings.

At the beginning, FIG. 3 will be explained as an example.

This is a case where a record sheet print application is used at an off-line printer 300. The record sheet print application is used to print a record sheet such as a call record sheet of a portable terminal 200 in the off-line printer 300. FIG. 3 shows license information of the record sheet print application. In the portable terminal 200, record sheet information showing a call history and so on is beforehand registered in the EPROM 56.

Firstly, a user begins by inputting an application acquisition request at the portable terminal 200.

At the portable terminal 200, when the application acquisition request is inputted, through steps S102 and S104, access is made to an application management server 100, a list of applications that the application management server 100 has registered and a statement that an application that is a target of acquisition that can be selected from the list are displayed. Here, the user selects a record sheet print application.

At the portable terminal 200, when the record sheet print application is selected, through steps S106 and S108, the license information shown in FIG. 3 is acquired from the application management server 100, and, based on the acquired license information, a content of the license information is displayed. Here, the user, when there is no problem of the displayed content, a confirmation of the acquisition of the record sheet print application is inputted.

At the portable terminal 200, when the confirmation is inputted, through step S112, an acquisition request for acquiring the record sheet print application is transmitted to the application management server 100.

At the application management server 100, when the application acquisition request is received, by an application supply port 12, the record sheet print application and the license information shown in FIG. 3 are read from an application registration DB 10, the read record sheet print application and the license information are sent to the portable terminal 200.

At the portable terminal 200, when the record sheet print application and the license information are received, through step S116, the received record sheet print application and license information are registered in the EPROM 56.

Next, a user inputs an application distribution request at the portable terminal 200.

At the portable terminal 200, when the application distribution request is inputted, through steps S202, owing to the radio communication device 60, a radio communication path with the off-line printer 300 is established. As a result, when the communication with the off-line printer 300 becomes possible, through step S206, a list of applications registered in the EPROM 56 and a statement that an application that is a subject to be distributed has to be selected from the list are displayed. Here, since the record sheet print application is registered in the list, the user selects a record sheet print application.

At the portable terminal 200, when the record sheet print application is selected, through steps S208 through S212, the record sheet print application and the license information shown in FIG. 3 are read from the EPROM 56, the read record sheet print application and the license information are sent to the off-line printer 300 together with the application registration request.

At the off-line printer 300, when the record sheet print application and the license information are received together with the registration request, through step S404, the received record sheet print application and the license information are registered in the memory device 84.

Next, the user inputs a record sheet print request at the portable terminal 200.

At the portable terminal 200, when the record sheet print request is inputted, the record sheet information is read from the EPROM 56, and the read record sheet information is sent to the off-line printer 300 together with a print request.

At the off-line printer 300, when the print request and the record sheet information are received, through steps S 500 and 502, the license information shown in FIG. 3 is read from the memory device 84, and from the read license information a license confirmation frequency is extracted. In the license information shown in FIG. 3, since “each time” is registered as the license confirmation frequency, it is judged that the license confirmation frequency does not show that the confirmation is applied only at a time when the application is used for the first time. Furthermore, through step S504, from the read license information the license confirmation address is extracted. In the information shown in FIG. 3, since “portable terminal” is registered as the license confirmation address, it is confirmed that the license confirmation address is the portable terminal 200.

Then, through step S506, owing to the radio communication device 80 a radio communication path with the portable terminal 200 is established. As a result, when the communication with the portable terminal 200 becomes possible, through step S510, the read license information and the license confirmation request are sent to the portable terminal 200.

At the portable terminal 200, when the confirmation request and the license information shown in FIG. 3 are received, through step S304, license information same as the received license information is searched from the EPROM 56. As a result, since the relevant license information is present, through step S308, from the received license information the license restriction is extracted. In the license information shown in FIG. 3, “none” is registered as the license restriction; accordingly, it is judged to have the eligibility for use of application. When the eligibility for use is certified, through step S310, a certification response is sent to the off-line printer 300.

Furthermore, through step S312, from the received license information, an accounting timing is extracted. In the license information shown in FIG. 3, since “at the utilization time” is registered as the accounting timing, the accounting timing is judged a time when the application is certified. Then, through step S314, based on the license information shown in FIG. 3, an accounting process is carried out. In the license information shown in FIG. 3, since “¥20” is registered as a service charge, in the accounting information registration table 420, as an application name “record sheet print application” and as the accounting charge “¥20” are registered as new record.

At the off-line printer 300, when receiving the certification response, through step S516, the certification result is correlated with the record sheet print application and registered in the memory device 84. Then, through steps S518 and S520, the record sheet print application is read from the memory device 84, and the read record sheet print application is executed. As a result, based on the received record sheet information, a print mechanism 86 prints the record sheet.

At the off-line printer 300, when the communication with the portable terminal 200 becomes impossible, through step S524, a statement to the effect that the application cannot be executed is displayed.

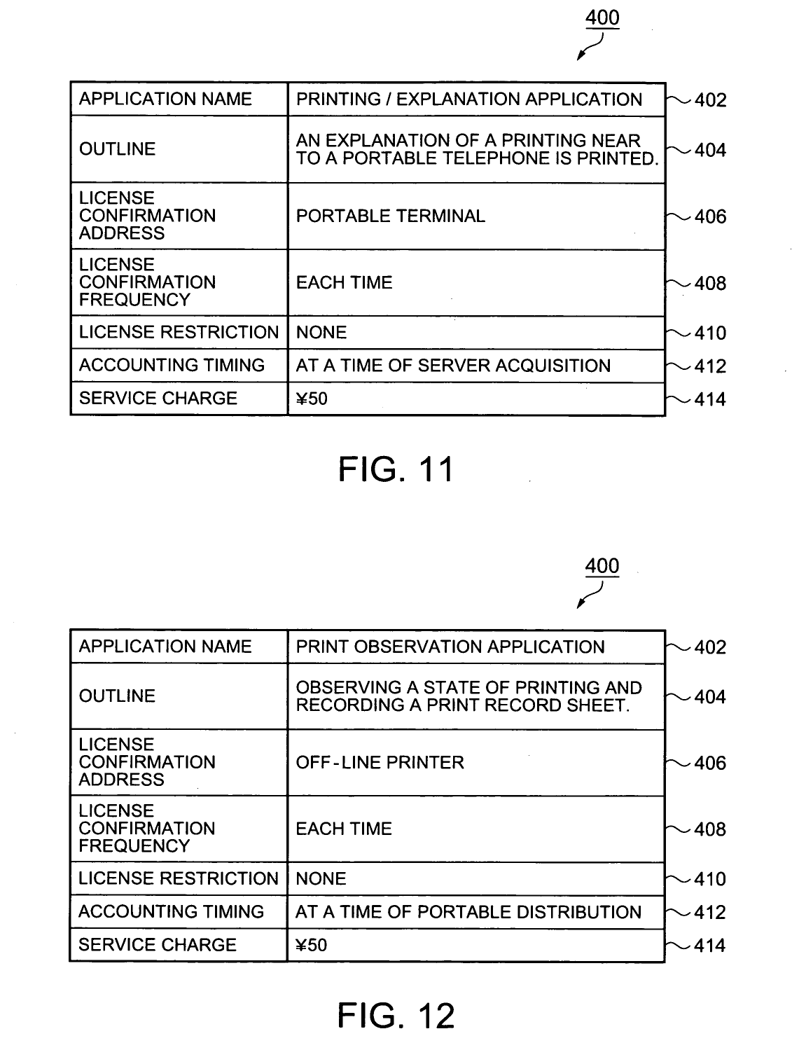

Next, another example will be explained with FIG. 11 as an example.

This is a case where a printing/explanation application is used at the off-line printer 300. The printing/explanation application, when the portable terminal 200 is brought closer to a particular printing, the off-line printer 300 prints an explanation of the printing.

FIG. 11 is a diagram showing license information of the printing/explanation application.

In the license information shown in FIG. 11, as an application name, “printing/explanation application”; as a license confirmation address, “portable terminal”; as a license confirmation frequency, “each time”; as license restriction, “none”; as an accounting timing, “server acquisition time”; and as a service charge, “¥50” are respectively registered.

The difference from the example shown in FIG. 3 is in the accounting timing.

At the portable terminal 200, when an acquisition request is transmitted to the application management server 100 and the printing/explanation application and license information shown in FIG. 11 are received, the received printing/explanation application and the license information are registered in the EPROM 56.

Furthermore, through step S118, from the received license information the accounting timing is extracted. Since in the license information in FIG. 11, as the accounting timing, the “server acquisition time” is registered, the accounting timing is judged as the application acquisition time. Then, through step S120, based on the license information shown in FIG. 11, an accounting process is carried out. In the license information in FIG. 11, as the service charge, “¥50” is registered; accordingly, in the accounting information registration table 420, as an application name, “printing/explanation application”; and as a service charge, “¥50” are respectively registered as new record.

The user, after distributing the printing/explanation application, brings the portable terminal 200 closer to a particular printing.

The off-line printer 300, when the portable terminal 200 is brought closer to a particular printing, according to a procedure similar to that of an example of FIG. 3, receives a certification response; accordingly, the certification result is correlated with the printing/explanation application and registered in the memory device 84. Then, the printing/explanation application is read from the memory device 84 and the read printing/explanation application is executed. As a result, the explanation of the particular printing is printed with the print mechanism 86.

Next, another example will be described with FIG. 12 as an example.

This is a case where a print observation application is utilized at an off-line printer 300. The print observation application observes a print state in the off-line printer 300 to record a print record sheet.

FIG. 12 is a diagram showing license information of the print observation application.

In the license information in FIG. 12, as an application name, “print observation application”; as a license confirmation address, “off-line printer”; as a license confirmation frequency, “each time”; as a license restriction, “None”; as an accounting timing, “portable distribution time”; and as a service charge, “¥50” are registered respectively.

Points different from FIG. 3 are the license confirmation address and the accounting timing.

A user, after acquiring the print observation application, at the portable terminal 200, inputs an application distribution request and selects the print observation application as a subject to be distributed.

At the portable terminal 200, when the print observation application is selected, the print observation application and the license information shown in FIG. 12 are read from the EPROM 56, and the read print observation application and the license information are transmitted to the off-line printer 300 together with a registration request of the application.

Furthermore, through step S214, from the received license information, an accounting timing is extracted. Since in the license information of FIG. 12, as the accounting timing, “portable distribution time” is registered, it is judged that the accounting timing is a time when the application is distributed. Then, through step S216, based on the license information of FIG. 12, an accounting process is carried out. In the license information of FIG. 12, “¥50” is registered as a service charge; accordingly, in the accounting information registration table 420, as the application name and the service charge, respectively, “print observation application” and “¥50” are registered as new record.

At the off-line printer 300, when the print observation application is distributed, the license information of FIG. 12 is read from the memory device 84, and from the read license information a license confirmation frequency is extracted. In the license information shown in FIG. 12, as the license confirmation frequency, “each time” is registered; accordingly, it is judged that the license confirmation frequency does not show that only at a first time of use of the application the confirmation is applied. Furthermore, through step S504, from the read license information, a license confirmation address is extracted. In the license information of FIG. 12, as the license confirmation address, the “off-line printer” is registered; accordingly, it is judged that the license confirmation address is not the portable terminal 200.

Then, through step S526, from the read license information, the license restriction is extracted. In the license information shown in FIG. 12, as the license restriction, “none” is registered; accordingly, it is judged eligible for use of application. When the eligibility for use of application is certified, the print observation application is read from the memory device 84, and the read print observation application is executed. As a result, a print state is observed and a print record sheet is recorded.

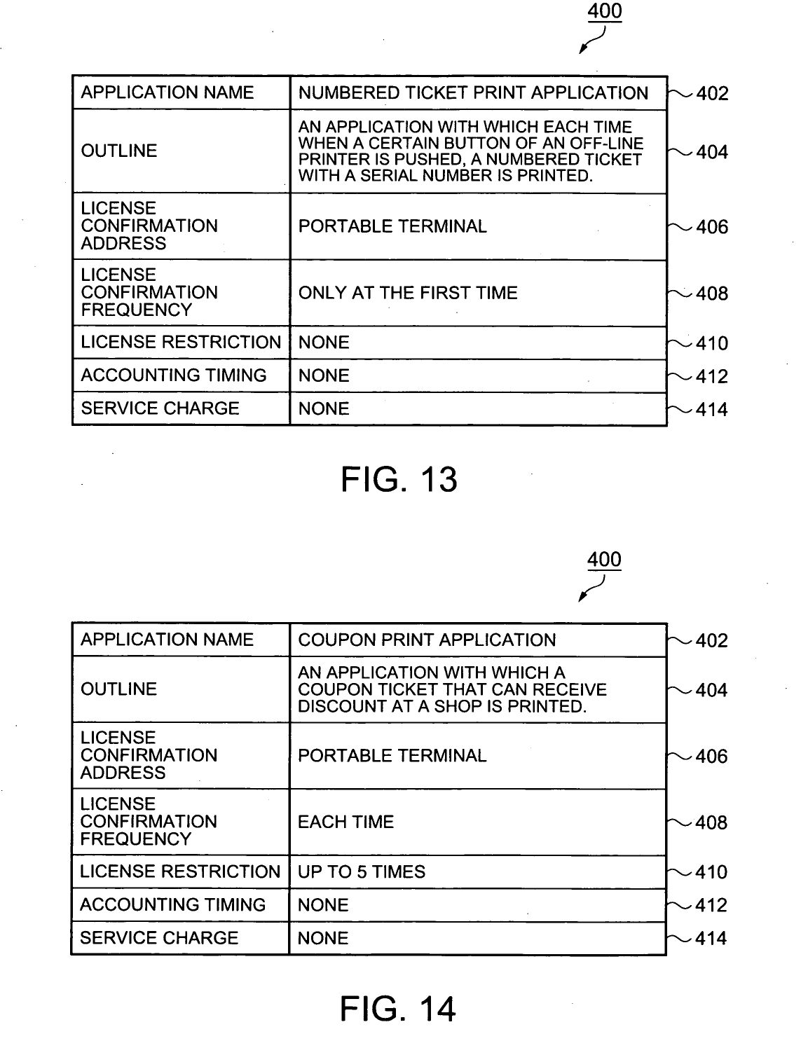

Next, still another example will be described with FIG. 13 as an example.

This is a case where the off-line printer 300 utilizes a numbered ticket print application. The numbered ticket print application allows the off-line printer 300 to print a numbered ticket with a sequence number one by one.

FIG. 13 is a diagram showing license information of the numbered ticket print application.

In the license information of FIG. 13, as the application name, license confirmation address, license confirmation frequency, license restriction, accounting timing, and service charge, “numbered ticket print application”, “portable terminal”, “only at the first time”, “none” and “none” are respectively registered.

The license confirmation frequency is different from the example of FIG. 3.

A user, after distributing the numbered ticket print application, pushes down a predetermined button of an operation panel 82 at the off-line printer 300.

The off-line printer 300, when a predetermined button is pushed down, reads the license information of FIG. 13 from the memory device 84 and extracts a license confirmation frequency from the read license information. In the license information of FIG. 13, as the license confirmation frequency, “only at the first time” is registered; accordingly, it is judged that the license confirmation frequency shows that the confirmation is applied only at a time when the application is used for the first time. Furthermore, through step S528, since the numbered ticket print application is never certified, it is judged that a certification result of the numbered ticket print application is not registered in the memory device 84. Accordingly, the license information of FIG. 13 and a confirmation request are sent to the portable terminal 200. Subsequently, since, to the transmission of the confirmation request, according to a procedure similar to that of the example of FIG. 3, certification response is received, the certification result is registered correlated with the numbered ticket print application in the memory device 84. Then, the numbered ticket print application is read from the memory device 84, and the read numbered ticket print application is executed. As a result, one numbered ticket with a predetermined sequence number is printed.

When the numbered ticket print application is executed second time or after that, the off-line printer 300, through step S 528, judges that the certification result of the numbered ticket print application is registered in the memory device 84. Accordingly, the numbered ticket print application is read from the memory device 84, and the read numbered ticket print application is executed. The certification result is erased from the memory device 84 when the off-line printer 300 is restarted.

Next, another example will be explained with FIG. 14 as an example.

This is a case where the off-line printer 300 utilizes a coupon print application. The coupon print application allows the off-line printer 300 to print coupons.

FIG. 14 is a diagram showing license information of the coupon print application.

In the license information shown in FIG. 14, as the application name, license confirmation address, license confirmation frequency, license restriction, accounting timing and service charge, “coupon print application”, “portable terminal”, “each time”, “up to 5 times”, “none” and “none” are respectively registered.

The license restriction is different from that of the example of FIG. 3.

A user, after distributing the coupon print application, pushes down a predetermined button of an operation panel 82 in the off-printer 300.

At the off-printer 300, when the predetermined button is pushed down, the license information of FIG. 14 and a confirmation request are sent to the portable terminal 200.

At the portable terminal 200, when the license information of FIG. 14 is received together with the confirmation request, from the received license information, the license restriction is extracted. In the license information shown in FIG. 14, as the license restriction, “up to 5 times” is registered; accordingly, when the coupon print application has been used up to now less than 5 times, the eligibility for use of application is judged yes. When the eligibility for use is certified, a certification response is sent to the off-line printer 300.

At the off-line printer 300, when the certification response is received, the coupon print application is read from the memory device 84, and the read coupon print application is executed. As a result, a coupon with which a commodity can be obtained at a discount at a shop is printed.

On the other hand, at the portable terminal 200, when the coupon print application has been used 5 times or more until now, it is judged not eligible for use of the application. When the eligibility for use of application is denied, a denial response is sent to the off-line printer 300.

The off-line printer 300, when receiving the denial response, displays a statement to the effect that the application cannot be executed.

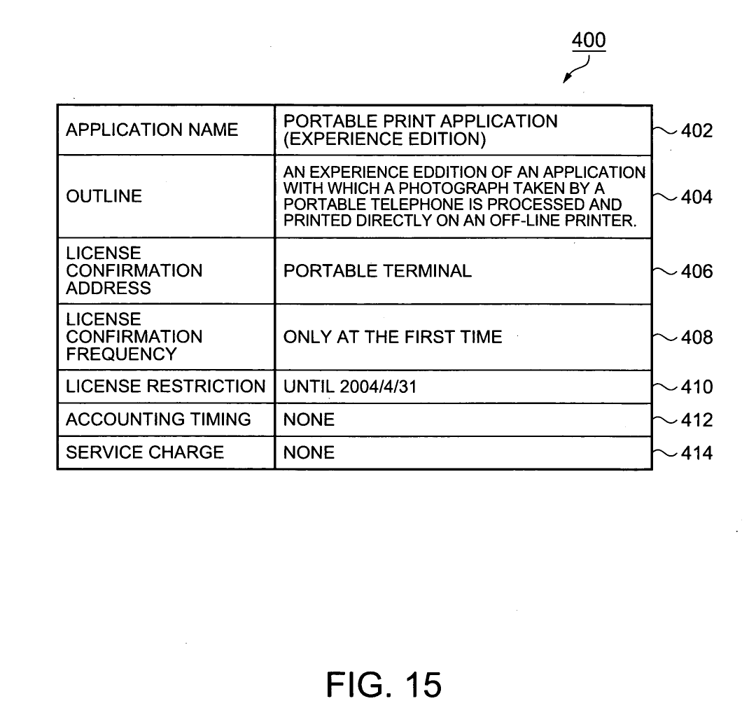

In the next place, still another example will be described with FIG. 15 as an example.

This is a case where the off-line printer 300 utilizes a portable print application. The portable print application allows the off-line printer 300 to process image information received from the portable terminal 200 and print a photograph.

FIG. 15 is a diagram showing license information of the portable print application.

In the license information of FIG. 15, the application name, license confirmation address, license confirmation frequency, license restriction, accounting timing, and service charge, respectively, are shown as “portable print application”, “portable terminal”, “only at the first time” , “until 2004/4/31”, “none” and “none”.

The license confirmation address, license confirmation frequency and license restriction are different from that of the example of FIG. 3.

A user, after the portable print application is distributed, inputs a print request of a photograph at the portable terminal 200.

At the portable terminal 200, when the print request of a photograph is inputted, from the EPROM 56, image information of a photograph is read, and the read image information is sent to the off-line printer 300 together with a print request.

At the off-line printer 300, when the print request and the image information are received, the license information of FIG. 15 is sent to the portable terminal 200 together with the confirmation request.

At the portable terminal 200, when the confirmation request and the license information of FIG. 15 are received, from the received license information, the license restriction is extracted. In the license information of FIG. 15, as the license restriction, “until 2004/4/31” is registered; accordingly, when the present date is before 2004/4/31, it is judged eligible for use of application. When the eligibility for use is certified, a certification response is sent to the off-line printer 300.

At the off-line printer 300, when the certification response is received, the portable print application is read from the memory device 84, and the read portable print application is executed. As a result, the received image information is processed, and, based on the processed image information, a photograph is printed.

On the other hand, at the portable terminal 200, when the present date is 2004/5/1 or after that, it is judged not eligible for use of the application. When the eligibility for use of the application is denied, a denial response is sent to the off-line printer 300.

The off-line printer 300, when the denial response is received, displays a statement to the effect that the application cannot be executed.

Thus, according to the embodiments, the portable terminal 200, when distributing the application and the license information corresponding thereto of the EPROM 56 to the off-line printer 300 and receiving the confirmation request together with license information, based on the received license information, judges whether it is eligible for use of application or not, and sends a certification response or denial response to the off-line printer 300. The off-line printer 300, prior to the execution of the application, sends the received license information and the confirmation request to the portable terminal 200, and, when receiving the certification response, executes the received application.

Thereby, at the portable terminal 200, the distribution of the application and the management of the license are carried out; accordingly, without establishing the connection environment with the network and local terminal on the off-line printer 300 side, the distribution of the application and the management of the license can be carried out. Furthermore, since the application and the license information are managed for each application, a plurality of licenses of applications can be managed separately.

Furthermore, according to the embodiments, the off-line printer 300, when the denial response is received or when the communication with the portable terminal 200 is judged impossible, inhibits the application from being executed.

Thereby, when the denial response is received from the portable terminal 200, or when the communication with the portable terminal 200 is impossible, since the application is inhibited from being executed, the likelihood of the application being used outside of the range of the license can be reduced.

Still furthermore, according to the embodiments, the off-line printer 300, depending on a content of the license information, only when the received application is executed for the first time, the eligibility for use of application is confirmed to the portable terminal 200.

Thereby, the number of times of and the amount of communication with the portable terminal 200 can be reduced. Furthermore, of the application of which eligibility for use is once confirmed, execution thereafter can be carried out without confirmation; accordingly, the convenience of the application can be improved.

Furthermore, according to the embodiments, the portable terminal 200, when the application is acquired, distributed or certified, carries out the accounting process to the use of the application.

Thereby, to the use of the application, relatively proper accounting can be carried out.

In the above embodiments, the portable terminal 200 is configured so as to send the certification response and the denial response to the off-line printer 300 as the certification judgment result; however, without restricting to this, it can be configured so as to send any one of the certification response and the denial response to the off-line printer 300. When the portable terminal 200 is configured so as to send only the certification response, the off-line printer 300, when judging that within a predetermined period after the transmission of the confirmation request the certification response is not received, judges that it has no eligibility for use of application. Furthermore, the portable terminal 200 is configured so as to send only the denial response, the off-line printer 300, when judging that within a predetermined period after the transmission of the confirmation request the denial response is not received, judges that it has the eligibility for use of application.

Furthermore, in the above embodiments, the off-line printer 300 is constituted so as to send, in a process of step S512, all license information to the portable terminal 200; however, without restricting to this, it may be constituted so as to partially send the license information. Specifically, among the license information, identification information for identifying an application (for instance, an application name) is sent. The portable terminal 200, when receiving the confirmation request and application identification information, based on the application identification information, can read the relevant license information. Accordingly, based on the read license information, according to a procedure similar to that of the abovementioned embodiments, a certification process can be carried out. This is, without restricting to the process of step S512, similar to the process of step S212.

Still furthermore, in the above embodiments, the off-line printer 300 is constituted so as to send, in the process of step S512, the license information to the portable terminal 200. In addition to this, for certifying the license restriction and so on at the portable terminal 200, it may be constituted also so as to send identification information (for instance, a device identifier) to the off-line printer 300.

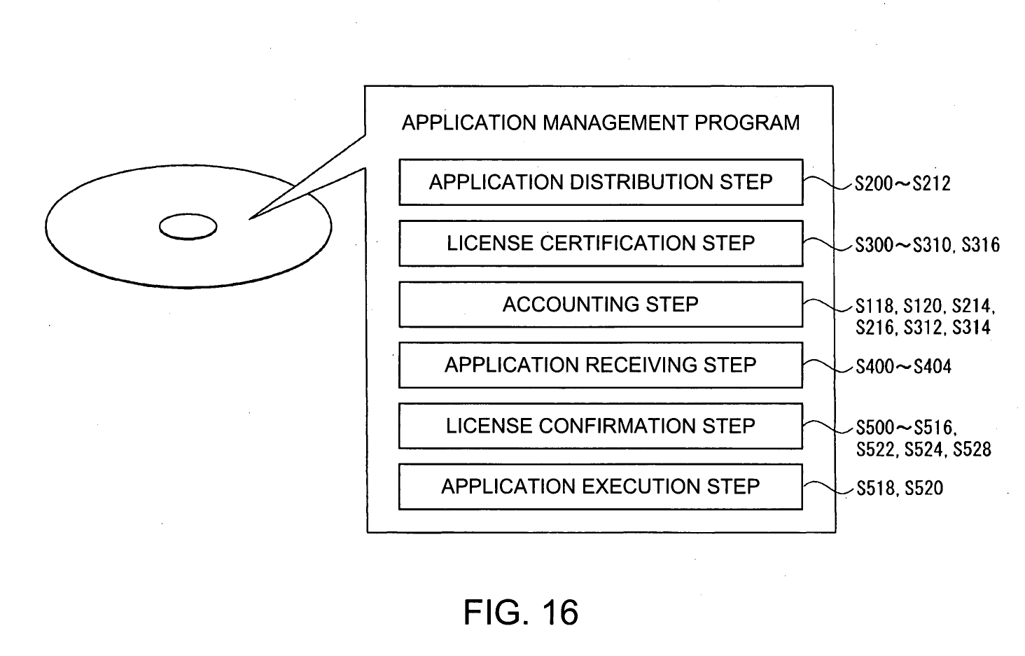

Furthermore, in the above embodiments, when processes shown in flowcharts shown in FIGS. 5 through 7, FIGS. 9 and 10 are carried out, in all cases, the control programs stored beforehand in the ROMs 52, 72 are executed. However, without restricting to this, as shown in FIG. 16, a program may be read from a memory medium that stores a program that shows these procedures in RAMs 54, 74 and executed.

FIG. 16 is a diagram showing a memory medium and a data structure thereof.

Here, the memory medium is a semiconductor memory medium such as a RAM, ROM or the like; a magnetic memory type memory medium such as a FD, HD or the like; an optical read memory medium such as a CD, CVD, LD, DVD or the like; or a magnetic write/optical read memory medium such as an MO. Irrespective of an electronic, magnetic or optical reading method, as far as the memory medium is a computer-readable one, all memory mediums are included.

Furthermore, in the above embodiments, the application management system, the device with application execution function, the portable terminal with application management function, the device program, the portable terminal program and memory medium, and the application management method involving the invention are applied to a case where applications of the off-line printer 300 are managed; however, without restricting to this, within a range that does not deviate from gist of the invention, these can be applied also to other cases. For instance, these can be applied to devices that are considered preferable to use without establishing a connection environment with the network or the local terminals such as home electric appliances. For instance, in place of the off-line printer 300, a copy machine, digital camera, TV, vending machine, game machine, projector, scanner, DVD player, HDD recorder, router, print server, electronic paper, home gateway, personal computer, PDA (personal Digital Assistant), network storage, audio device, portable telephone, PHS (registered trade mark)(Personal Handyphone System), watch type PDA, STB (Set Top Box), POS (Point Of Sale) terminal, FAX machine, telephone (including IP telephone), and other devices can be cited.

Still furthermore, in place of the portable terminal 200, by constituting so as to have the accounting information registration port 22 and accounting port 24, it can be applied to a portable telephone, PDA, IC card with communication function and RFID (Radio Frequency IDentification) card. Furthermore, by constituting without the accounting information registration port 22 and accounting port 24, it can be applied to an automobile (car stereo and ETC terminal), electronic dictionary and a watch.

1. An application management system that communicably connects a device that executes an application and a portable terminal that manages the application;
wherein said portable terminal includes:
an application memory unit that stores the application and license information for certifying the eligibility for use of the application;
an application distribution unit that distributes the application and license information corresponding thereto stored in the application memory unit to the device; and
a license certification unit that certifies the eligibility for use of the application; and
wherein said device includes:
an application receiving unit that receives the application and the license information;
a license confirmation unit that confirms, based on the license information from the portable terminal, the eligibility for use of the application; and
an application execution unit that executes the application;
wherein the license confirmation unit sends license information received at the application receiving unit together with a confirmation request to the portable terminal, with the license confirmation unit receiving a certification judgment result of the eligibility for use of the application, and based on the received certification judgment result, makes the application received at the application receiving unit executable; and
wherein the license certification unit receives the confirmation request and the license information, and wherein the license certification unit, based on the received license information, judges whether it has the eligibility for use of the application or not, and sends a certification judgment result thereof to the device.

2. The application management system according to claim 1,
wherein the device is an off-line printer that acquires print data not through a network but from a memory medium to print.

3. The application management system according to claim 1,
wherein the license confirmation unit, when judging that the certification judgment result denies the eligibility for use of the application or that communication with the portable terminal is impossible, restricts the application from being executed.

4. The application management system according to claim 1,
wherein the license confirmation unit, until the eligibility for use of the application is certified, confirms, at a time when the application is started-up, the portable terminal the eligibility for use of the application received at the application receiving unit.

5. The application management system according to claim 1,
wherein the portable terminal has an accounting unit that, when the application distribution unit distributes the application or when the license certification unit certifies the eligibility for use of the application, executes an accounting process to use of the application.

6. An application management system that communicably connects a device that executes an application and a portable terminal that manages the application,
wherein the portable terminal comprises:
a license information memory unit that correlates and stores license information for certifying the eligibility for use of the application;
an application distribution unit that distributes to the device the application and license information corresponding to the application in the license information memory unit; and
a license certification unit that certifies the eligibility for use of the application; and
wherein the device comprises:
an application receiving unit that receives the application and the license information;
a license confirmation unit that confirms, based on the license information from the portable terminal, the eligibility for use of the application; and
an application execution unit that executes the application;
wherein the license confirmation unit sends license information received at the application receiving unit together with a confirmation request to the portable terminal, with the license confirmation unit receiving a certification judgment result of the eligibility for use of the application, and, based on the received certification judgment result, makes the application received at the application receiving unit executable; and
wherein the license certification unit receives the confirmation request and the license information, and wherein the license certification unit, based on the received license information, judges whether it has the eligibility for use of the application or not, and sends a certification judgment result thereof to the device.

7. A device with an application execution function that executes an application, said device comprising:
an application receiving unit that receives the application and license information for certifying the eligibility for use of the application;
a license confirmation unit that based on the license information confirms to an external terminal the eligibility for use of the application; and
an application execution unit that executes the application, wherein the license confirmation unit sends the license information received at the application receiving unit together with a confirmation request to the external terminal, with the license confirmation unit receiving a certification judgment result of the eligibility for use of the application, and, based on the received certification judgment result, makes the application executable by the application execution unit.

8. The device according to claim 7,
wherein the device is an off-line printer that acquires print data not through a network but from a memory medium to print.

9. The device according to claim 7,
wherein the license confirmation unit, when judging that the certification judgment result denies the eligibility for use of the application or that communication with the external terminal is impossible, restricts the application from being executed.

10. The device according to claim 7,
wherein the license confirmation unit, until the eligibility for use of the application is certified, confirms the external terminal the eligibility for use of the application received at the application receiving unit at a time when the application is started up.

11. A portable terminal with an application management function that manages an application, comprising:
an application memory unit that stores an application and correlates and stores license information for certifying the eligibility for use of the application;
an application distribution unit that distributes the application and license information corresponding thereto to the device; and
a license certification unit that certifies the eligibility for use of the application;
wherein the license certification unit, when receiving a confirmation request and the license information, based on the received license information, judges whether it has the eligibility for use of application or not, and sends the certification judgment result to the device.

12. The portable terminal according to claim 11, further comprising:
an accounting unit that, when the application distribution unit distributes the application, or when the license certification unit certifies the eligibility for use of the application, carries out an accounting process to use of the application.

13. A portable terminal with an application management function that manages an application, comprising:
a license information memory unit that correlates and memorizes license information for certifying the eligibility for use of the application and the application;
an application distribution unit that distributes the application and license information corresponding thereto to a device; and
a license certification unit that certifies the eligibility for use of the application;
wherein the license certification unit, when receiving a confirmation request and the license information, based on the received license information, judges whether it has the eligibility for use of application or not, and sends the certification judgment result to the device.

14. A programmable computer comprising:
a memory;
a program stored in the memory that makes the computer execute a process comprising the steps of receiving an application that receives the application and license information for certifying the eligibility for use of the application; sending a confirmation request and license information to an external terminal to determine the eligibility for use of the application; and executing an application that executes the application,
wherein the computer sends the license information together with a confirmation request to the external terminal and receives a certification judgment result of the eligibility for use of the application, the computer, based on the received certification judgment result, making the application executable.

15. A programmable computer for a portable terminal that manages an application, comprising:
an application memory unit that memorizes license information for certifying the eligibility for use of the application correlated with the application;
a program that makes the computer execute a process including distributing an application and the license information corresponding thereto to a device; and certifying the eligibility for use of the application,
wherein the computer receives a confirmation request and the license information, and, based on the received license information, judges whether the portable terminal has the eligibility for use of the application or not, and sends the certification judgment result to the device.

16. The programmable computer according to claim 15, further comprising:
a program that, when the application is distributed at the distributing the application, or when the certifying the license certifies the eligibility for use of the application, makes the computer execute a process made of accounting that executes accounting to the use of the application.

17. A programmable computer for a portable terminal that manages an application, comprising:
a license information memory unit that memorizes and correlates license information for certifying the eligibility for use of the application, comprising:
a program stored in the memory that makes the computer execute a process comprising distributing the application and license information corresponding thereto to a device and certifying a license for eligibility for use of the application;
wherein the computer receives the license information together with a confirmation request, and based on the received information, judges whether the portable terminal is eligible for use of the application or not, and wherein the computer sends the certification judgment result to the device.

18. A computer readable memory medium that memorizes a device program that makes a computer in the device operate the device to execute an application, comprising:
the memory medium storing a program that makes the computer execute a process including receiving an application and license information for use of application; sending a license confirmation request to an external terminal regarding the eligibility for use of the application; and executing an application that executes the application;
wherein the computer sends license information together with a confirmation request to the external terminal and receives a certification judgment result of the eligibility for use of application, and, based on the received certification judgment result, makes the application executable.

19. A computer readable memory medium comprising:
a program stored in the memory medium for operating a portable terminal that manages an executable application, the memory medium having an application memory unit that memorizes license information for certifying the eligibility for use of application correlated with the application, and the memory medium memorizing a program that makes a computer in the portable terminal execute a process comprising distributing an application and license information corresponding thereto to a device and, further, certifying the eligibility for use of application;
wherein the computer receives a confirmation request and the license information, and, based on the received license information, judges whether the portable terminal has eligibility for use of application, and with the computer sending the certification judgment result to the device.

20. The memory medium according to claim 19, the memory medium further storing a program that, when the application is distributed at the distributing an application, or when the certifying a license certifies the eligibility for use of the application, makes the computer execute a process made of accounting that executes an accounting process to the use of the application.

21. Apparatus comprising a computer readable memory medium that stores a program for a portable terminal having a computer that manages whether an application can be executed by another device, the computer being capable of using a license information memory unit that memorizes license information for certifying the eligibility for use of application correlated with the application, the memory medium storing a program that makes the computer execute a process comprising distributing an application and license information corresponding thereto to the device, and certifying the eligibility for use of application;
wherein the computer receives a confirmation request and the license information, and, based on the received license information, judges whether the portable terminal has the eligibility for use of application, and wherein the computer sends the certification judgment result to the device.

22. An application management method that communicably connects a device that executes an application and a portable terminal that manages the application, comprising:
in the portable terminal, reading the application and license information corresponding thereto from an application memory unit that stores the license information for certifying the eligibility for use of an application correlated with the application; and distributing the application and license information to the device;
in the device, receiving the application and the license information, with the device sending the licensing information and a confirmation request to the portable terminal;
the portable terminal, based on the received license information, judging whether there is eligibility for use of application or not, and with the portable terminal sending the certification judgment result to the device; and
wherein the device, based on the received certification judgment result, executes the application.

23. An application management method that communicably connects a device that executes an application and a portable terminal that manages the application, comprising:
in the portable terminal, reading license information corresponding to the application from a license information memory unit that stores the license information for certifying the eligibility for use of application correlated with the application, and distributing the application and license information to the device;
in the device, receiving the application and the license information, with the device sending the licensing information and a confirmation request to the portable terminal;
the portable terminal, based on the received license information, judging whether there is eligibility for use of application or not, with the portable terminal sending the certification judgment result to the device; and
wherein the device, based on the received certification judgment result, executes the application.
